(19) United States
(12) Patent Application Publication
(10) Pub. No.: US 2022/0156658 A1
(43) Pub. Date: May 19, 2022

(54) SYSTEM AND METHOD FOR MANAGING RESOURCES

(71) Applicant: Telefonaktiebolaget LM Ericsson (publ), Stockholm (SE)

(72) Inventors: Saravanan MOHAN, CHENNAI (IN); Perepu SATHEESH KUMAR, CHENNAI (IN)

(73) Assignee: Telefonaktiebolaget LM Ericsson (publ), Stockholm (SE)

(21) Appl. No.: 17/435,859

(22) PCT Filed: Mar. 5, 2019
(86) PCT No.: PCT/IN2019/050189

§ 371 Date: Sep. 2, 2021

(51) Int. Cl. G06Q 10/06; H04L 41/0654

(52) U.S. Cl. CPC G06Q 10/06311; H04L 41/0654; G06Q 10/06315

(57) ABSTRACT

A method for managing resources includes applying an ensemble model having a plurality of sub-models such that an output of the ensemble model is a weighted average of predictions from the sub-models, and is a prediction of multiple parameters. The method includes determining that an accuracy of the ensemble model is below a first threshold; and as a result, optimizing weights for the predictions from the sub-models. Optimizing weights for the predictions from the sub-models includes: updating the weights selected by the reinforcement learning by looking ahead over a prediction horizon and optimizing the reward function at the given time instance. The method further includes using the prediction of the multiple parameters to manage resources.

### TECHNICAL FIELD

Disclosed are embodiments related to predicting multiple parameters and managing resources.

### BACKGROUND

Predicting a parameter (a.k.a. variable) from historical data is a common practice. One area where this arises involves efficiently handling human resources (such as domain specialists), and particularly the time of the resources. In managed services, for example, this is a great challenge. Many service industries are looking to reduce the manpower necessary for various tasks (such as maintenance), and are attempting to replace human workers with intelligent robots. This means that fewer human resources are available to be allotted to very critical tasks. Due to the demanding requirements of many service industries, various attempts have been made to better allocate resources, such as algorithms to optimize route selection and only allocating engineers for tasks after getting details such as that a given fault has occurred at a given location. Better allocation of resources is generally applicable to many industrial service scenarios. Some examples include attending to the services of “smart objects” in new Internet-of-Things (IoT) type environments (such as cities and particular industrial sites). For discussion purposes, a specific problem will be addressed below using the telecommunications service industry as an example.

A base transceiver station (BTS) is a piece of equipment that facilitates wireless communication between a user equipment (UE) (such as a mobile handset) and a network (such as a wireless communications network like a 4G network or a 5G network). These BTSs include many components, and often times will need repairs associated with those components in order to remain in good working order. These repairs can be handled efficiently by service engineers who are specialized in the domain. The time taken for the repair typically depends on the experience of the service engineer and level of the difficulty of the problem. There can be thousands of towers (which can house a BTS) in a normal city; therefore, it can be a complex task to assign human resources to handle and solve problems as they arise in time to address the problems and maintain good network conditions.

There are known approaches available in the literature to predict a single parameter such as the number of faults. One approach is to model the faults as time-series data and predict the location and possible number of faults in a computer-software system. Other approaches address the usage of reinforcement learning (RL) in the management of resources based on the prediction information of the tasks.

### SUMMARY

Assigning resources should be done optimally. For example, assigning service engineers to handle repairs (such as in the telecommunications service industry example discussed above) should be done optimally so that the repairs can be handled efficiently, e.g. to minimize time and/or cost and/or network downtime. Another factor to consider is that the service engineers may be located anywhere in a city, and they can be assigned to repair a tower which is far away from their current location. Therefore, the method of assigning repairs should consider the distance from the current location of the service engineer to the location of the tower and/or the expected time to traverse that distance.

Given all the above considerations, if faults necessitating repair and their specific location are known in advance of those faults, then resources can be more optimally allocated and the problems can be repaired more efficiently, e.g. more cheaply and more quickly. However, predicting faults in advance is a complex problem and implicates various other issues some of which are hard or impossible to know in advance with certainty, e.g. outer environmental parameters. In view of all of this, there is a need for improved resource allocation, such as for an improved digital workforce which can predict fault invariant parameters on a real-time basis and automate and improve the workforce handling those issues. Such improvements could be useful in a wide variety of industrial applications, e.g. for managing the repair of “smart objects” in IoT environments. The improvements can also create value in solving problems quickly and providing the most satisfaction to customers utilizing the services being offered.

Problems with existing solutions for predicting faults abound. For example, such systems are generally limited to predicting a single parameter. Further, such systems have trouble being applied in the above telecommunications service industry scenario, or generally where there are various equipment with different specifications (such as in an IoT platform). Also, because these systems are generally limited to predicting a single parameter, they cannot readily be modified to handle the prediction of multiple parameters, e.g. multiple correlated features relevant to a fault (such as fault location, time of fault, and fault type). Moreover, existing work with RL typically requires the user to specify a high quality reward matrix in order to produce reasonably accurate predictions, which is difficult to obtain in real-time scenarios.

In embodiments described here, systems and methods are provided for predicting faults in advance by optimally updating weights (e.g. by tuning a reward function) in consideration with the multiple predictions learned from the past rewards and using this information to optimize the current rewards. Embodiments are able to optimize the current rewards without the use of any rules (e.g. domain-specific rules) for predicting multiple parameters. In some embodiments such parameters include fault-invariants such as time of fault, location of fault, and fault type.

Embodiments are able to predict multiple parameters while minimizing prediction error.

As an example of how embodiments may be used, consider the telecommunications service industry example discussed above. Service engineers may be assigned tasks within maximum resolution time which depends on e.g. (1) predicting faults periodically (e.g. every four-hour period) from the historical and current data; and (2) assigning these faults optimally to service engineers on a real-time basis by considering the engineer's present location, the distance and/or time to reach the location of the fault, the engineer's domain knowledge and expertise, and the level and type of faults involved. At each period (e.g., every four-hour period) the prediction models can be further optimized based on additional data.

Advantages include that the prediction and allocation may be advantageously applied to a large number of different settings, including efficient allocation of human resources in diverse industries, and efficient allocation of resources more generally. For example, computing resources in a cloud-computing type environment can be allocated by some embodiments. The prediction and allocation may also be applied when resources are very limited or otherwise constrained, including during natural disaster or other types of irregular events that cause strain on a system's resources.

According to a first aspect, a method for managing resources is provided. The method includes applying an ensemble model, the ensemble model comprising a plurality of sub-models such that an output of the ensemble model is a weighted average of predictions from the sub-models, and such that the output is a prediction of multiple parameters. The method further includes determining that an accuracy of the ensemble model is below a first threshold. The method further includes optimizing weights for the predictions from the sub-models as a result of determining than an accuracy of the trained ensemble model is below a first threshold. Optimizing weights for the predictions from the sub-models includes applying reinforcement learning, such that the weights are selected for a given time instance to improve prediction accuracy based at least in part on a reward function; and updating the weights selected by the reinforcement learning by looking ahead over a prediction horizon and optimizing the reward function at the given time instance. The method further includes using the prediction of the multiple parameters to manage resources.

In some embodiments, updating the weights selected by the reinforcement learning by looking ahead over a prediction horizon and optimizing the reward function at the given time instance comprises:

Step 1) initializing weights for the predictions from the sub-models;
Step 2) computing predictions of multiple parameters over the prediction horizon using the weights for the predictions from the sub-models;
Step 3) computing a minimization function to update the reward function to minimize prediction error, whereby the weights for the predictions from the sub-models are updated;
Step 4) computing the predictions of multiple parameters over the prediction horizon using the weights for the predictions from the sub-models that were updated in step 3; and
Step 5) determining whether a prediction error is less than a second threshold.

In some embodiments, as a result of step 5, it is determined that the prediction error is not less than a second threshold, and updating the weights selected by the reinforcement learning further comprises: discarding a sample used in step 2 for computing the predictions of multiple parameters over the prediction horizon using the weights for the predictions from the sub-models; and repeating steps 2 through 5, until it is determined that the prediction error is less than the second threshold. In some embodiments, computing the minimization function of step 3 comprises optimizing

_{R}^{min}Σᵢ₌ₖ₊₁^{k+N}(f(R,y[i−p],u[i−p])−y[i]), p=1,2,3 . . . ,

where R is the reward function, y[i] is the actual output calculated at the given time instant i, f(.) is the reinforcement learning model and u is the multiple parameters.

In some embodiments, at least one of the multiple parameters is related to a fault and wherein using the prediction of the multiple parameters to manage resources comprises assigning resources to correct the predicted fault. In some embodiments, the multiple parameters includes (i) a location of a fault, (ii) a type of the fault, (iii) a level of a node where the fault occurred, and (iv) a time of the fault. In some embodiments, using the prediction of the multiple parameters to manage resources comprises applying an integer linear programming (ILP) problem as follows:

$${\sum }_{{}_{{a}_{ij}} j = 1}^{{}^{min} M} {\sum }_{i = 1}^{N} {a}_{j i} d + {\sum }_{j = 1}^{M} {\sum }_{i = 1}^{N} {a}_{j i} {t}_{j i}$$

$$subject to \{ \begin{matrix}{\sum }_{j = 1}^{M} {\sum }_{i = 1}^{N} {a}_{j i} = M \\ {\sum }_{j = 1}^{M} {a}_{j i} \leq 1 ∀ i = 1 , . . . , N \\ {a}_{j i} = \{ 0 , 1 \} \\ Additional Constraints\end{matrix}$$

where d is the distance to the location of the fault, and tᵢⱼ is the time taken by resource i to reach the location j, where M is a total number of predicted faults in a time period, where the constraint Σⱼ₌₁^{M} Σᵢ₌₁^{N} aⱼᵢ=M ensures that there are M resources assigned, where the constraint Σⱼ₌₁^{M} aⱼᵢ≤1∀i=1, . . . , N ensures that almost one object is assigned to one resource, and where the constraint aⱼᵢ={0,1} ensures a resource is either selected or not.

In some embodiments, using the prediction of the multiple parameters to manage resources comprises assigning human resources based on one or more of the multiple parameters. In some embodiments, using the prediction of the multiple parameters to manage resources comprises assigning computing resources based on one or more of the multiple parameters.

According to a second aspect, a node adapted to perform the method of any one of the embodiments of the first aspect is provided. In some embodiments, the node includes a data storage system; and a data processing apparatus comprising a processor. The data processing apparatus is coupled to the data storage system, and the data processing apparatus is configured to apply an ensemble model, the ensemble model comprising a plurality of sub-models such that an output of the ensemble model is a weighted average of predictions from the sub-models, and such that the output is a prediction of multiple parameters. The data processing apparatus is further configured to determine that an accuracy of the ensemble model is below a first threshold. The data processing apparatus is further configured to optimize weights for the predictions from the sub-models as a result of determining than an accuracy of the trained ensemble model is below a first threshold. Optimizing weights for the predictions from the sub-models includes applying reinforcement learning, such that the weights are selected for a given time instance to improve prediction accuracy based at least in part on a reward function; and updating the weights selected by the reinforcement learning by looking ahead over a prediction horizon and optimizing the reward function at the given time instance. The data processing apparatus is further configured to use the prediction of the multiple parameters to manage resources.

According to a third aspect, a node is provided. The node includes an applying unit configured to apply an ensemble model, the ensemble model comprising a plurality of sub-models such that an output of the ensemble model is a weighted average of predictions from the sub-models, and such that the output is a prediction of multiple parameters. The node further includes a determining unit configured to determine that an accuracy of the ensemble model is below a first threshold. The node further includes an optimizing unit configured to optimize weights for the predictions from the sub-models as a result of the determining unit determining than an accuracy of the trained ensemble model is below a first threshold. Optimizing weights for the predictions from the sub-models includes: applying reinforcement learning, such that the weights are selected for a given time instance to improve prediction accuracy based at least in part on a reward function; and updating the weights selected by the reinforcement learning by looking ahead over a prediction horizon and optimizing the reward function at the given time instance. The node further includes a managing unit configured to use the prediction of the multiple parameters to manage resources.

According to a fourth aspect, a computer program is provided. The computer program includes instructions which when executed by processing circuitry of a node causes the node to perform the method of any one of the embodiments of the first aspect.

According to a fifth aspect, a carrier containing the computer program of the fourth aspect is provided. The carrier is one of an electronic signal, an optical signal, a radio signal, and a computer readable storage medium.

### BRIEF DESCRIPTION OF THE DRAWINGS

The accompanying drawings, which are incorporated herein and form part of the specification, illustrate various embodiments.

FIG. 1 illustrates a system according to an embodiment.

FIG. 2 illustrates a flow chart according to an embodiment.

FIG. 3 illustrates a chart of a reward plotted against number of iterations according to an embodiment.

FIG. 4 is a flow chart illustrating a process according to an embodiment.

FIG. 5 is a diagram showing functional units of a node according to an embodiment.

FIG. 6 is a block diagram of a node according to an embodiment.

### DETAILED DESCRIPTION

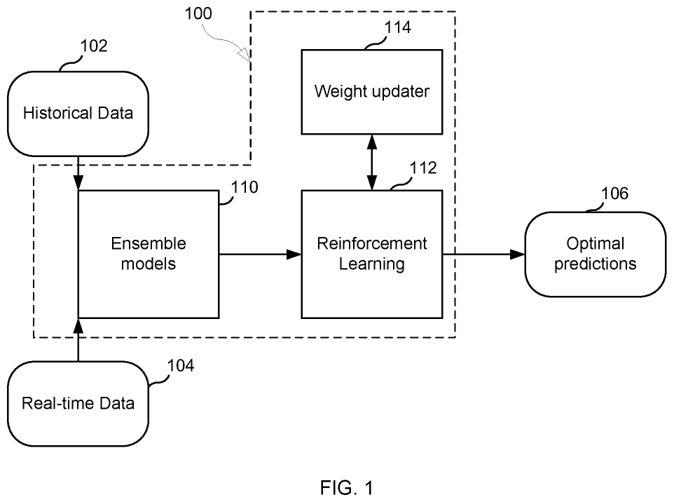

As shown in FIG. 1, a system 100 according to an embodiment includes a number of modules. Ensemble models 110 may take as input historical data 102 and real-time data 104, and the output may be fed into the reinforcement learning 112. Reinforcement learning 112 and weight updater 114 are in communication with each other, such that the weight updater 114 may modify the reinforcement learning 112 to improve the predictions. In embodiments, weight updater 114 and reinforcement learning 112 may also have access to historical data 102 and real-time data 104. The output of reinforcement learning 112 are the optimal predictions 106.

System 100 may be used in a wide variety of resource allocation problems. For example, system 100 may be used to optimally assign computing resources in a cloud-computing type environment. As another example, system 100 may be used to predict and assign the faults in a telecommunications network to service engineers based on the engineers' present location, distance and/or time to travel to the fault location, domain knowledge, and also based on the fault's level or severity and the type of fault. In allocating resources in this example, two steps are provided, which include (i) predicting fault invariants and (ii) assigning service engineers to the predicted faults in a timely manner.

Ensemble models 110 may include a set of N models, resulting in N predictions at a given time instant. Using an ensemble model in this manner can be advantageous for certain types of data. For example, the alarm data for faults in the telecommunications service industry is noisy, it may have many outliers, and the time scale of the faults is not uniform (for example, a first fault can occur at 2 AM, a second fault at 2:01 AM, and a third fault at 4:00 AM). In addition, some of the variables discussed here are categorical variables. In this case, using only one model can lead to poor predictions. Also, every model will have its own limitations. Hence, to address this, system 100 employs ensemble models to provide for more accurate predictions. Instead of relying on a single model, a prediction is generated from taking the output of N models. However, a problem with the ensemble approach is that the output of the ensemble model depends on the choice of weights chosen. A simple choice of weights is the arithmetic mean of all the predictions. This choice is not always optimal, however, as sometimes it is appropriate to weigh one model more than another.

To address the issue of selecting weights for the ensemble models 110, system 100 employs a reinforcement learning 112. The reinforcement learning 112 may use reinforcement learning (RL) methods to select weights. Typical RL methods tend to require very precise rewards in order to produce good results. Here, system 100 introduces a weight updater 114 to help to produce optimal weights by computing a prediction of future fault invariants and minimizing the prediction error. In some embodiments, weight updater 114 may apply a reward tuning function to optimally update weights.

The individual components of system 100 are now explained in greater detail.

The prediction is computed as an ensemble average of predictions obtained from different models. Assuming that there are N such models (for ensemble models 110) which predict N different values in a given time, an average of all these N models is computed as:

$$S ( t ) = {\sum }_{k = 1}^{N} {w}_{k} {p}_{k} ( t )$$

where pₖ are each of the predictions obtained from the N different models; and wₖ are the corresponding weights for the different models.

To make sure that the prediction S(t) is optimal, it is important to select weights wₖ that are optimal. The reinforcement learning 112 and weight updater 114 work together to achieve this. The aim of the RL here is to interact with the environment and learn the optimal weights for the time instant. The learning of the optimal weights depends also on an error obtained from previous time instants. In RL, the objective is to change the state of the agent such that the agent is maximum rewarded i.e.

_{Reward}^{max}state of the agent

To apply this, we need to define states and actions. The states here represent the prediction obtained at time t and the nearby values (e.g. what is previous in sequence). The actions represent the choice of weights. The reward matrix is computed at every time instant based on the inverse of the prediction error obtained at the time instant (for example, to minimize the prediction error, which would maximize the prediction accuracy). The state transition corresponds to the choice of weighting functions which influence the prediction of time data. The objective of RL is to choose optimal weights such that the overall prediction accuracy should be improved.

In the RL, X={xᵢ} is a set of states, U is a set of actions, P_{XU} are the state transition probabilities, and r is the reward function for state transition xᵢ. Hence the total payoff can be computed as:

R=r(x₀)+γr(x₁)+γ²r(x₂)+ . . .

In the above equation γ is called a discount factor. Typically, the rewards are chosen as scalar values, and in some case where a large number of states and actions exist, deep RL may be used to approximate the reward function. In RL the idea to choose actions uₜ such that the total payoff R is maximized. It is similar to a Markov Decision Process where the transition probabilities are estimated by a maximum likelihood estimate.

The predictions are computed periodically, and after a given period, the problem is solved again to obtain optimal predictions for the next period. For the next period, the real-time data from the preceding period may be added to the models as additional historic data. For example, for the telecommunications service industry example, predictions may be computed for every four hours by taking the real-time faults that occurred during the four-hour time period. At the end of the time period, the faults that occurred are added to the historic data thereby improving the performance of the model. The reason for the choosing a four-hour period is because the average time spent by a service engineer to repair the fault is about four hours. A longer or shorter period may also be chosen.

It should be noted the predictions obtained from this step may not be optimal. For good predictions, existing RL requires a lot of historical data and particularly data that is not noisy. (The fault data in the telecommunications service industry example, for instance, is particularly noisy). In many scenarios, there may not be enough historical data available, it may be too noisy, or there may not be space available to store it. Therefore, the policy learnt in existing RL may not be optimal. To improve this, the weight updater 114 is provided to help to learn the optimal policy by predicting the future fault invariants and changing the current policy such that the prediction error is minimized.

Updating weights (such as by reward tuning) as described here may be considered analogous to a model predictive controller (MPC), where there is a significant overlap with the RL techniques. The idea of MPC has not been used previously in the design of optimal rewards.

To review, the objective of an MPC is to drive the output of a process y[k] (where k is the time at which the output is recorded) to a fixed value s as quick as possible. This is achieved by predicting the output of the system over the next N instants ahead in time and changing the input of the system at a current time such that the actual output reaches the fixed value s as soon as possible. The output of the process y[k] is controlled by changing the input of the process u[k]. This is analogous to the RL mechanism, where s is the optimal policy, y[k] is the state of the process and u[k] is set of actions to be taken. In MPC, the model between u[k] and y[k] is used to minimize the value y[k]−s. Mathematically, it can be written as:

$${\sum }_{{ }^{{u}^{i = k + 1}}}^{{min}_{k + N}} ( f ( u [ i ] ) - s ) \qquad ( 1 )$$

In the above equation, N is known as a prediction horizon, f(.) is the model built between the output and input to the process. As a note to the reader, the N used here is different from, and not related to, the number of models used in the set of ensemble models; rather, it refers to the number of time instants that the prediction will predict ahead of time, hence the name “prediction horizon.” The optimization problem is solved at the current instant and the input u[k] is estimated. Similarly, the input is calculated at every next sampling instant by solving the optimization problem:

$${\sum }_{{ }^{{u}^{i = k + 2}}}^{{min}_{k + N + 1}} ( f ( u [ i ] ) - s ) \qquad ( 2 )$$

Here f( ) may be chosen as the state-space model.

In the case of prediction as discussed here, the input u[k] consists of past data when there are no independent variables. In the case of independent variables, the input u[k] consists of both past data and independent variables.

Applying this to the system 100, first the process is modeled with a deep RL model with the choice of random rewards; then, using the computed predictions, the following optimization problem may be solved:

$${\sum }_{{R}^{i = k + 1}}^{{min}_{k + N}} ( f ( R , y [ i - p ] , u [ i - p ] ) - y [ i ] ) , p = 1 , 2 , 3 . . . \qquad ( 3 )$$

where the output at the current instant is predicted as

ŷ[i]=f(R,y[i−p],u[i−p])

In the above equation R is the reward chosen to compute the predictions, y[i] is the actual output calculated at the instant i. In this equation f(.) is the RL model built during the process and the u is the set of independent variables.

It should be remarked that the weights chosen at the end of this step may or may not be an optimal one in a strict sense. The optimality of the solution depends on many factors, such as the initial choice of rewards, the current predictions, the choice of the models, and so on. Notwithstanding, predictions obtained at the end of this step have lower prediction error than that of the predictions obtained without the usage of the weight updater (e.g., applying a reward tuning function), and such predictions are referred to as optimal predictions 106.

The pseudo-code for updating weights by the weight updater is given below. The pseudo code to predict the time of the fault in the table is provided, however the code to predict other parameters will have similar calculations.
Input—time series data of fault time F_{T}, T=0, . . . , H−1
Initialize

$${W}_{0} = {[ \frac{1}{N} \frac{1}{N} \frac{1}{N} . . . ]}^{T} ,$$

r₀=[1 1 1 . . . ]^{T}, K=0 and P=10.
Here the N referred to is the number of ensemble models (i.e. the initial weight W₀ weights all models equally).
1. Collect the first P samples of the data.
2. Compute the current predictions and future predictions of the model using the choice of the weights W_{K} for data F_{T}, T=0, . . . , P−1.
3. Solve the minimization problem in (3) to compute the optimal rewards to minimize the prediction error. Assume the new weights obtained are W_{K+1}.
4. Using the optimal rewards obtained compute the current and future predictions of the model using the new weights W_{K+1}.
5. Is the sum of prediction errors is less than a threshold?
   Yes; stop the algorithm and use the rewards to calculate the predictions.
   No; discard one sample and repeat steps 2 to 4 for T=1, . . . , P.
6. Repeat until all H samples are covered.

Based on the prediction output, it is possible to then assign or allocate resources. Allocating resources will depend on the nature of resources being allocated. For example, for a cloud-computing type environment, where the resources include computing resources, different computing resources may have heterogeneous capabilities (e.g. number of graphics processors, available RAM, size of L2 cache).

Turning to the telecommunications service industry example previously discussed, resources may include service engineers. These engineers may have different levels of experience and may be positioned at different geographic locations, for instance. The problem of assigning the service engineers, in some embodiments, can be solved as an integer linear programming (ILP) problem where the decision variables are either 0 or 1. It is known how to solve such ILP efficiently; for example, solvers such as Gurobi can be easily integrated with CVX. The proposed formulation of the ILP problem uses parameters like a distance a service engineer has to travel, domain expertise, and time to reach the destination. The final function to be solved is

$${min}_{{a}_{i j}} {\sum }_{j = 1}^{M} {\sum }_{i = 1}^{N} {a}_{j i} d + {\sum }_{j = 1}^{M} {\sum }_{i = 1}^{N} {a}_{j i} {t}_{j i}$$

$$subject to \{ \begin{matrix}{\sum }_{j = 1}^{M} {\sum }_{i = 1}^{N} {a}_{j i} = M \\ {\sum }_{j = 1}^{M} {a}_{j i} \leq 1 ∀ i = 1 , . . . , N \\ {a}_{j i} = \{ 0 , 1 \} \\ Additional Constraints\end{matrix}$$

where d is the distance travelled by a service engineer, and tᵢⱼ is the time taken by the service engineer i to reach the destination j. The first constraint Σⱼ₌₁^{M} Σᵢ₌₁^{N} aⱼᵢ=M ensures that there are M (total number of predicted faults in the four-hour duration) objects assigned. The second constraint Σⱼ₌₁^{M} aⱼᵢ≤1∀i=1, . . . , N ensures that almost one object is assigned to one person. The third constraint aⱼᵢ={0,1} ensures that the service engineer is either selected or not.

Using the above ILP technique, all objects will be assigned to all the service engineers optimally.

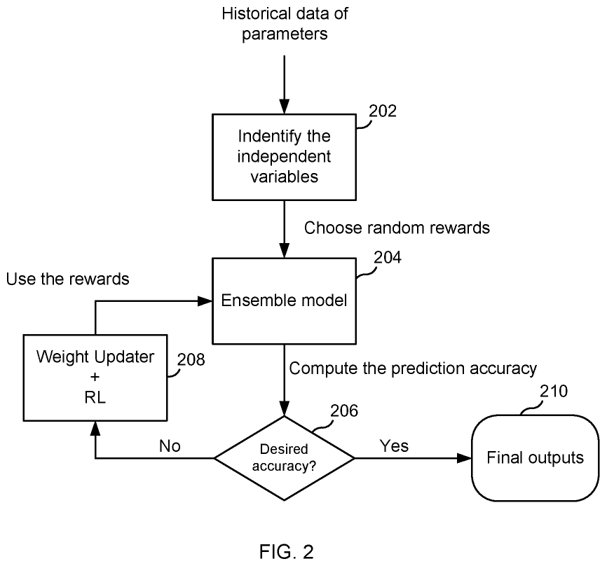

FIG. 2 illustrates a flow chart according to an embodiment. Based, for example, on historical data of parameters, independent parameters are identified at step 202. (These may include, for example, parameters related to managed services, shared services, customer services, or other service-domain type parameters.) Independent parameters are not correlated with each other; generally, step 202 may separate dependent and independent variables from each other. From here, step 204 proceeds to applying an ensemble model. A random set of weights may be selected initially in some embodiments, while in other embodiments some other mechanism may be identified for setting the initial weights. The ensemble model is applied to the real-time data to generate a set of predictions, and the weights are then applied from which an accuracy can be computed. At step 206, the accuracy is compared to a threshold desired accuracy value. If the accuracy is good enough, the final outputs are provided at 210 and the process stops. If the accuracy is not good enough, at step 208 reinforcement learning 112 and weight updater 114 are applied as previously described. Doing so will generate a new set of weights to apply to the ensemble model output at step 204, and the accuracy can again be checked to the threshold. This process can loop until the desired accuracy is achieved, optionally being limited to a maximum number of iterations.

A couple of illustrations will now be described.

Illustration 1: In this illustration, based on the telecommunications service industry example, the possible faults occurring in a particular object along with the level and type of fault and the possible time of fault are to be predicted. For this, we assume the history of the faults is known along with the level and type of faults and time of faults. Sample data is shown in the Table 1.

TABLE 1
Sample Fault Data

| | | | |
|---|---|---|---|
| ALARM (X.733) | BTS - Base | 600013 | (Jun. 11, 2017 |
| | Tranceiver Station - 2G | | 17:00:00) |
| ALARM (X.733) | BTS - Base | 600013 | (May 7, 2017 |
| | Tranceiver Station - 2G | | 09:00:00) |
| ALARM (X.733) | BTS - Base | 600015 | (Mar. 4, 2017 |
| | Tranceiver Station - 2G | | 09:00:00) |
| ALARM (X.733) | DNS - Domain | 600018 | (Mar. 8, 2017 |
| | Name System | | 14:00:00) |
| ALARM (X.735) | Others | 600015 | (Apr. 1, 2017 |
| | | | 13:00:00) |
| ALARM (X.735) | Others | 600017 | (Oct. 7, 2017 |
| | | | 02:00:00) |
| ALARM (X.735) | BTS - Base | 600017 | (Sep. 28, 2017 |
| | Tranceiver Station - 2G | | 13:00:00) |
| ALARM (X.735) | BTS - Base | 600015 | (Jul. 6, 2017 |
| | Tranceiver Station - 2G | | 05:00:00) |
| ALARM (X.733) | BTS - Base | 600017 | (Mar. 28, 2017 |
| | Tranceiver Station - 2G | | 08:00:00) |
| ALARM (X.733) | BTS - Base | 600013 | (Mar. 27, 2017 |
| | Tranceiver Station - 2G | | 03:00:00) |
| . . . | . . . | . . . | . . . |

A deep learning model has been trained on historical data such as this (as a part of ensemble method), to understand and predict the faults. This results in a set of ensemble models. Since the data considered in this illustration is noisy and can have outliers (e.g. some towers have one or less faults), the model results in poor accuracy. An example of an outlier may be the third row in table 1 above, where a specific alarm type (X.733) has happened at particular tower in a particular location only one time. This is an outlier and similar outliers can exist in the data. Hence, to improve the accuracy of the model, modifying the ensemble method by using RL and weight updater modules as described herein can be beneficial.

In any reinforcement learning algorithm, a rewards function must be specified. An example of the rewards function can be a constant function and it may be deduced from the past data. For example, from the table above, there are three instances of a specific fault type (X.733) in a particular tower at a particular location (600013). In this case, the reward of the state (fault at the location 600013) could be calculated as 3/(total number of faults data). A similar constant function could be calculated for the remaining faults. This choice of reward function, however, is not typically optimal, as the noisy data can lead to more reward than is appropriate. Another problem with this choice is that the optimal policy calculation can take longer to converge. Another choice of rewards, for example, could be a polynomial function giving more weight to more repeated faults and less weight to less repeated faults. This also may not be optimal. These reward functions can result in poorer predictions as the choice of the reward functions is independent of the environment.

Tests were run using 10,000 sample faults (with data such as that shown in Table 1). For these tests, 8,000 faults were used for training and 2,000 faults were used for testing the models. The prediction horizon used was 2, i.e. the rewards for every next sample was predicted based on the prediction error obtained for the next two samples. As a result, rewards were computed; as an example, the first 6 sample entries so computed were {0.5,0.4,0.3,0.43,0.54,0.21}. The rewards were then further fed to the system to compute the predictions. Choosing a high value for the desired accuracy threshold increases the number of iterations and can also increases the problem of over-fitting. On the other hand, choosing a lower value can result in poorer predictions. Sufficient care therefore should be taken for selecting this value.

The output of the minimization problem (that is, equation (3) above) results in optimal rewards being calculated. Once the rewards were calculated, the RL model was used to obtain the predictions. Based on the prediction error obtained, the rewards were then recalculated by predicting the rewards for next instants by solving the optimization problem for N future instants, by considering them

$${\sum }_{{R}^{i = k + 2}}^{{min}_{k + N + 1}} ( f ( R , y [ i - p ] , u [ i - p ] ) - y [ i ] ) , p = 1 , 2 , 3 . . . \qquad$$

If required (depending on the desired accuracy), the rewards are once again calculated (by solving the optimization problem at next instant) to improve the accuracy of the predictions.

The type of the solution (such as global or local) depends on the model chosen to implement the process. For a one-layer network with linear activation function, the model is linear and hence, the minimization problem results in a global solution and can easily get a solution. However, if the network has multiple layers and if the activation network is non-linear, then the optimization problem is non-linear and converges to local solution. Embodiments can readily adapt to both cases.

Illustration 2: In this illustration, based on the telecommunications service industry example, fault alarms in a real-time scenario are predicted. Alarm data was obtained from a service provider, and collected in the span of four months (first four months of 2017). Three months of the data was used to train the model, and the fourth month of the data was used for testing. The data used is shown in part in table 2 below.

TABLE 2
Sample Fault Data

| | | | |
|---|---|---|---|
| ALARM (X.733) | BTS - Base | 600013 | (Jan. 3, 2017 |
| | Tranceiver Station - 2G | | 17:06:00) |
| ALARM (X.733) | BTS - Base | 600017 | (Jan. 1, 2017 |
| | Tranceiver Station - 2G | | 17:06:00) |
| ALARM (X.733) | BTS - Base | 600019 | (Jan. 30, 2017 |
| | Tranceiver Station - 2G | | 10:30:00) |
| ALARM (X.733) | DNS - Domain | 600003 | (Feb. 3, 2017 |
| | Name System | | 04:12:00) |
| ALARM (X.733) | Others | 600013 | (Jan. 26, 2017 |
| | | | 08:30:00) |
| ALARM (X.733) | Others | 600006 | (Jan. 11, 2017 |
| | | | 13:12:00) |
| ALARM (X.733) | BTS - Base | 600008 | (Jan. 19, 2017 |
| | Tranceiver Station - 2G | | 14:17:00) |
| ALARM (X.733) | BTS - Base | 600016 | (Jan. 25, 2017 |
| | Tranceiver Station - 2G | | 17:12:00) |
| ALARM (X.733) | BTS - Base | 600012 | (Jan. 06, 2017 |
| | Tranceiver Station - 2G | | 07:54:00) |
| ALARM (X.733) | BTS - Base | 600012 | (Jan. 29, 2017 |
| | Tranceiver Station - 2G | | 12:12:00) |
| ALARM (X.733) | Others | 600003 | (Feb. 2, 2017 |
| | | | 20:06:00) |
| ALARM (X.733) | Others | 600006 | (Feb. 3, 2017 |
| | | | 05:36:00) |
| Not Defined | Others | 600015 | (Jan. 24, 2017 |
| | | | 08:17:00) |
| ALARM (X.733) | Network - Other | 600008 | (Jan. 28, 2017 |
| | | | 16:06:00) |
| Not Defined | Others | 600018 | (Jan. 22, 2017 |
| | | | 21:06:00) |
| Not Defined | Others | 600015 | (Jan. 17, 2017 |
| | | | 17:48:00) |
| Not Defined | Others | 600009 | (Jan. 8, 2017 |
| | | | 12:48:00) |
| Not Defined | Others | 600014 | (Jan. 13, 2017 |
| | | | 06:06:00) |
| Not Defined | Others | 600011 | (Jan. 31, 2017 |
| | | | 05:00:00) |
| ALARM (X.733) | BTS - Base | 600003 | (Jan. 26, 2017 |
| | Tranceiver Station - 2G | | 02:54:00) |
| ALARM (X.733) | BTS - Base | 600007 | (Jan. 29, 2017 |
| | Tranceiver Station - 2G | | 07:54:00) |
| ALARM (X.733) | Others | 600016 | (Jan. 20, 2017 |
| | | | 01:12:00) |
| . . . | . . . | . . . | . . . |

While the underlying data included more columns, we focused here on alarm type, node type, location, and time of the fault. It should be noted that the columns (Alarm type, node type, location) are categorical variables while the time is a continuous variable.

The data considered here is obtained from 19 locations across the world. There are 4 alarm types and 20 different node types in the data. The 4 alarm types considered are shown in table 3 below. The unique node types considered are shown in table 4 below.

TABLE 3
Unique Alarm types in data
Unique Alarm Type

ALARM (X.733)
Not Defined
Processing Error (X.733)
Security Service Violation (X.736)

TABLE 4
Unique Node Type
Unique Node Type

BTS - Base Tranceiver Station - 2G
DNS - Domain Name System
Others
Network - Other
BTS - Base Tranceiver Station
Node B - RBS in 3GPP
Local Switch
GSS Server
CPE - Customer Premises Equipment - Router
Packet Switches
Provisioning Servers
eNode B - Ericsson
BSC - Base Station Controller
LAN Switch
GGSN - GPRS Gateway Support Node
RNC - Radio Network Controller
Wireline Access Node
IP Router
Charging and Billing Servers
Service Layer - SAPC
MSC - Mobile Switching Center
MGW - Media Gateway - Ericsson

The different parameters (here the columns of data including Alarm type, node type, location, and time) were analyzed for any correlation. Correlation plots of the data were obtained in order to facilitate this analysis. The Alarm type and node type were correlated, and time was correlated with itself. We also found that the location was not correlated with any of the parameters. Therefore for this illustration, location was not used as a predictor variable. The data was then filtered across each location and the following process performed to predict the remaining variables.

Predicting the Time of the Fault.

According to the data for this illustration, the time of the fault occurring is independent of all the other variables. The time of the fault was therefore modeled as a time series model. First, the data was split into 80% that was used for training the model and 20% that was used for testing the model. Next, an ensemble model was built on the training data and used to predict the time of the fault. Consequently, the accuracy of each model was calculated and depending on the accuracy, the RL and weight updater modules described above were used to calculate the rewards by assigning proper weights to the ensemble model. This is repeated until the desired accuracy is achieved.

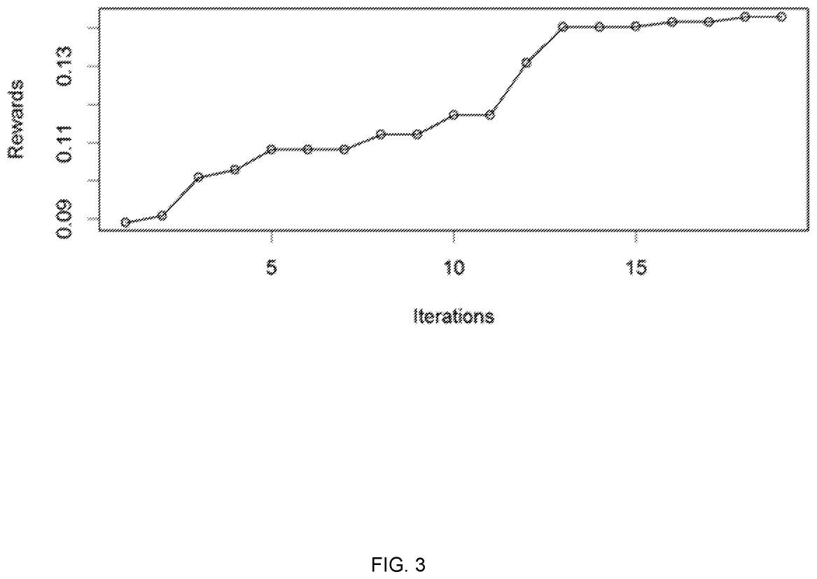

As part of this, one of the rewards was plotted as a function of the number of iterations, as shown in FIG. 3. From the plot, it is evident that the reward increases with the number of iterations and reaches a steady state after about 13 iterations, suggesting that the algorithm is converged (that is, the same reward results in the same weights which in turn results in the same predictions).

The desired accuracy is generally chosen based on the application. In this illustration, a desired accuracy of 99% was used for time-series prediction, as the time should be estimated with high accuracy. In addition to time, the node type and type of the fault are also predicted.

Predicting the Node Type

According to the data for this illustration, the node type is correlated only with the time of the fault. Therefore, to predict the node type, time of the fault was considered as an independent variable. Similar to the previous work on prediction of the time, the same steps apply to predict the node type. In this example, the desired accuracy for node type was set at 85%.

Predicting the Alarm Type

According to the data for this illustration, the alarm type is correlated with both the time of the fault and node type. Therefore, to predict the alarm type, time of the fault and node type were considered as independent variables. Again, the same steps to predict the time or node type are also applicable for predicting the alarm type. In this example, the desired accuracy was set at 85%.

After predicting the time of fault, the node type, and the alarm type, the accuracies of these predictions were recorded for observation. These accuracies are provided below:

TABLE 5
Accuracies obtained from using RL + Weight Updater method

| | Accuracy | Accuracy | Accuracy |
|---|---|---|---|
| Location | Time | Node | Alarm Type |
| 600001 | 99.9501 | 85.8407 | 91.1504 |
| 600002 | 99.9462 | 89.7196 | 86.9159 |
| 600003 | 99.9478 | 87.7358 | 90.5660 |
| 600004 | 99.9458 | 85.8407 | 85.8407 |
| 600005 | 99.9501 | 85.8407 | 91.1504 |
| 600006 | 99.9510 | 90.1786 | 76.7857 |
| 600007 | 99.9490 | 91.1504 | 88.4956 |
| 600008 | 99.9480 | 87.1560 | 82.5688 |
| 600009 | 99.9524 | 85.9813 | 84.1121 |
| 600010 | 99.9524 | 85.9813 | 84.1121 |
| 600011 | 99.9458 | 85.8407 | 85.8407 |
| 600012 | 99.9510 | 90.1786 | 76.7857 |
| 600013 | 99.9529 | 82.0755 | 81.1321 |
| 600014 | 99.9490 | 91.1504 | 88.4956 |
| 600015 | 99.9502 | 89.1892 | 90.0901 |
| 600016 | 99.9529 | 82.0755 | 81.1321 |
| 600017 | 99.9535 | 87.8049 | 82.1138 |
| 600018 | 99.9545 | 81.5789 | 78.9474 |
| 600019 | 99.9533 | 85.9649 | 90.3509 |

From the table, it is evident that the proposed algorithm is able to make good predictions with the real-time data. For the sake of comparison, similar predictions were made using only RL without modifying the reward function with the weight updater, and the accuracies of these predictions were also recorded for observation. In this case, the RL has not converged because of the noisiness of the data. The method uses a stochastic gradient kind of approach to estimate the optimal rewards. The accuracies obtained are given in the table below.

TABLE 6
Accuracies obtained using only the
RL method (without weight updater)

| | | | Accura- |
|---|---|---|---|
| Location | Accuracy_Time | Accuracy_Node | cy_Alarm_Type |
| 600001 | 0.71714 | 0.66574 | 0.62646 |
| 600002 | 0.68295 | 0.67314 | 0.60951 |
| 600003 | 0.74951 | 0.62390 | 0.60164 |
| 600004 | 0.79581 | 0.66579 | 0.68022 |
| 600005 | 0.74925 | 0.66455 | 0.62137 |
| 600006 | 0.77075 | 0.60212 | 0.66442 |
| 600007 | 0.77483 | 0.63756 | 0.66278 |
| 600008 | 0.73490 | 0.61455 | 0.62036 |
| 600009 | 0.76974 | 0.65804 | 0.68278 |
| 600010 | 0.73992 | 0.68229 | 0.66864 |
| 600011 | 0.78556 | 0.65825 | 0.60645 |
| 600012 | 0.73713 | 0.66529 | 0.63648 |
| 600013 | 0.70593 | 0.68460 | 0.61820 |
| 600014 | 0.77356 | 0.60030 | 0.64066 |
| 600015 | 0.78644 | 0.63542 | 0.60030 |
| 600016 | 0.78293 | 0.64015 | 0.65818 |
| 600017 | 0.71847 | 0.66696 | 0.69009 |
| 600018 | 0.76314 | 0.66322 | 0.67942 |
| 600019 | 0.79467 | 0.66561 | 0.66133 |

As further evidence, these results can also be compared to another system for predicting faults. Using the method disclosed in Ostrand, Thomas J., Elaine J. Weyuker, and Robert M. Bell, “Predicting the location and number of faults in large software systems.” IEEE Transactions on Software Engineering 31, no. 4 (2005): 340-355, the accuracy of the predictions are shown in the table below.

TABLE 7
Accuracies obtained using related art [Ostrand 2005] method

| | | | Accura- |
|---|---|---|---|
| Location | Accuracy_Time | Accuracy_Node | cy_Alarm_Type |
| 600001 | 0.417138 | 0.657384 | 0.264553 |
| 600002 | 0.682945 | 0.731422 | 0.095088 |
| 600003 | 0.749508 | 0.238975 | 0.016441 |
| 600004 | 0.095809 | 0.657922 | 0.80223 |
| 600005 | 0.249254 | 0.645503 | 0.213738 |
| 600006 | 0.170746 | 0.021189 | 0.644215 |
| 600007 | 0.274834 | 0.375565 | 0.627753 |
| 600008 | 0.434897 | 0.145489 | 0.203649 |
| 600009 | 0.469735 | 0.580402 | 0.827831 |
| 600010 | 0.839916 | 0.822931 | 0.686361 |
| 600011 | 0.285558 | 0.582545 | 0.064481 |
| 600012 | 0.637127 | 0.652919 | 0.36484 |
| 600013 | 0.505929 | 0.845972 | 0.18203 |
| 600014 | 0.873563 | 0.002975 | 0.406582 |
| 600015 | 0.386442 | 0.354181 | 0.003014 |
| 600016 | 0.382929 | 0.401509 | 0.581787 |
| 600017 | 0.318469 | 0.669632 | 0.900896 |
| 600018 | 0.763138 | 0.632194 | 0.794154 |
| 600019 | 0.494673 | 0.656133 | 0.613314 |

As you can see, the accuracies obtained using the proposed algorithm are good when compared with the existing method which depicts the efficacy of the proposed method.

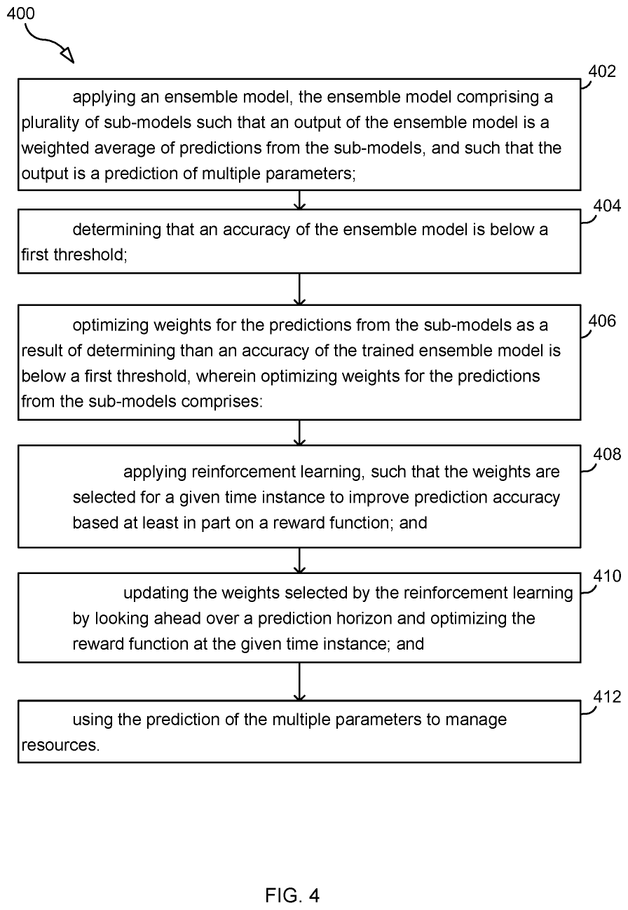

FIG. 4 illustrates a flow chart showing process 400 according to an embodiment. Process 400 is a method for managing resources. The method includes applying an ensemble model, the ensemble model comprising a plurality of sub-models such that an output of the ensemble model is a weighted average of predictions from the sub-models, and such that the output is a prediction of multiple parameters (step 402). The method further includes determining that an accuracy of the ensemble model is below a first threshold (step 404). The method further includes optimizing weights for the predictions from the sub-models as a result of determining than an accuracy of the trained ensemble model is below a first threshold (step 406). Optimizing weights for the predictions from the sub-models includes applying reinforcement learning, such that the weights are selected for a given time instance to improve prediction accuracy based at least in part on a reward function (step 408); and updating the weights selected by the reinforcement learning by looking ahead over a prediction horizon and optimizing the reward function at the given time instance (step 410). The method further includes using the prediction of the multiple parameters to manage resources (step 412).

In some embodiments, updating the weights selected by the reinforcement learning by looking ahead over a prediction horizon and optimizing the reward function at the given time instance comprises:

Step 1) initializing weights for the predictions from the sub-models;
Step 2) computing predictions of multiple parameters over the prediction horizon using the weights for the predictions from the sub-models;
Step 3) computing a minimization function to update the reward function to minimize prediction error, whereby the weights for the predictions from the sub-models are updated;
Step 4) computing the predictions of multiple parameters over the prediction horizon using the weights for the predictions from the sub-models that were updated in step 3; and
Step 5) determining whether a prediction error is less than a second threshold.

In some embodiments, as a result of step 5, it is determined that the prediction error is not less than a second threshold, and updating the weights selected by the reinforcement learning further comprises: discarding a sample used in step 2 for computing the predictions of multiple parameters over the prediction horizon using the weights for the predictions from the sub-models; and repeating steps 2 through 5, until it is determined that the prediction error is less than the second threshold. In some embodiments, computing the minimization function of step 3 comprises optimizing

_{R}^{min}Σᵢ₌ₖ₊₁^{k+N}(f(R,y[i−p],u[i−p])−y[i]), p=1,2,3 . . . ,

where R is the reward function, y[i] is the actual output calculated at the given time instant i, f(.) is the reinforcement learning model and u is the multiple parameters.

In some embodiments, at least one of the multiple parameters is related to a fault and wherein using the prediction of the multiple parameters to manage resources comprises assigning resources to correct the predicted fault. In some embodiments, the multiple parameters includes (i) a location of a fault, (ii) a type of the fault, (iii) a level of a node where the fault occurred, and (iv) a time of the fault. In some embodiments, using the prediction of the multiple parameters to manage resources comprises applying an integer linear programming (ILP) problem as follows:

$${\sum }_{{{a}_{ij}}^{j = 1}}^{{min}_{M}} {\sum }_{i = 1}^{N} {a}_{j i} d + {\sum }_{j = 1}^{M} {\sum }_{i = 1}^{N} {a}_{j i} {t}_{j i}$$

$$subject to \{ \begin{matrix}{\sum }_{j = 1}^{M} {\sum }_{i = 1}^{N} {a}_{j i} = M \\ {\sum }_{j = 1}^{M} {a}_{j i} \leq 1 ∀ i = 1 , . . . , N \\ {a}_{j i} = \{ 0 , 1 \} \\ Additional Constraints\end{matrix}$$

where d is the distance to the location of the fault, and tᵢⱼ is the time taken by resource i to reach the location j, where M is a total number of predicted faults in a time period, where the constraint Σⱼ₌₁^{M} Σᵢ₌₁^{N} aⱼᵢ=M ensures that there are M resources assigned, where the constraint Σⱼ₌₁^{M} aⱼᵢ≤1∀i=1, . . . , N ensures that almost one object is assigned to one resource, and where the constraint aⱼᵢ={0,1} ensures a resource is either selected or not.

In some embodiments, using the prediction of the multiple parameters to manage resources comprises assigning human resources based on one or more of the multiple parameters. In some embodiments, using the prediction of the multiple parameters to manage resources comprises assigning computing resources based on one or more of the multiple parameters.

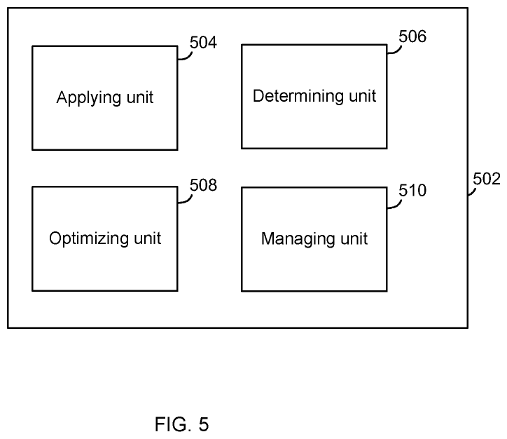

FIG. 5 is a diagram showing functional units of a node 502 for managing resources, according to an embodiment. Node 502 includes an applying unit 504 configured to apply an ensemble model, the ensemble model comprising a plurality of sub-models such that an output of the ensemble model is a weighted average of predictions from the sub-models, and such that the output is a prediction of multiple parameters. Node 502 further includes a determining unit 506 configured to determine that an accuracy of the ensemble model is below a first threshold. The method further includes an optimizing unit 508 configured to optimize weights for the predictions from the sub-models as a result of the determining unit 506 determining than an accuracy of the trained ensemble model is below a first threshold. Optimizing weights for the predictions from the sub-models includes applying reinforcement learning, such that the weights are selected for a given time instance to improve prediction accuracy based at least in part on a reward function; and updating the weights selected by the reinforcement learning by looking ahead over a prediction horizon and optimizing the reward function at the given time instance. Node 502 further includes a managing unit 510 configured to use the prediction of the multiple parameters to manage resources.

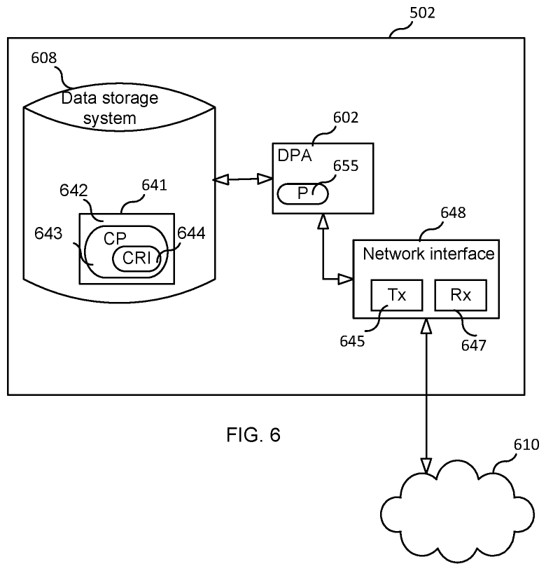

FIG. 6 is a block diagram of a node (such as node 502), according to some embodiments. As shown in FIG. 6, the node may comprise: processing circuitry (PC) 602, which may include one or more processors (P) 655 (e.g., a general purpose microprocessor and/or one or more other processors, such as an application specific integrated circuit (ASIC), field-programmable gate arrays (FPGAs), and the like); a network interface 648 comprising a transmitter (Tx) 645 and a receiver (Rx) 647 for enabling the node to transmit data to and receive data from other nodes connected to a network 610 (e.g., an Internet Protocol (IP) network) to which network interface 648 is connected; and a local storage unit (a.k.a., “data storage system”) 608, which may include one or more non-volatile storage devices and/or one or more volatile storage devices. In embodiments where PC 602 includes a programmable processor, a computer program product (CPP) 641 may be provided. CPP 641 includes a computer readable medium (CRM) 642 storing a computer program (CP) 643 comprising computer readable instructions (CRI) 644. CRM 642 may be a non-transitory computer readable medium, such as, magnetic media (e.g., a hard disk), optical media, memory devices (e.g., random access memory, flash memory), and the like. In some embodiments, the CRI 644 of computer program 643 is configured such that when executed by PC 602, the CRI causes the node to perform steps described herein (e.g., steps described herein with reference to the flow charts). In other embodiments, the node may be configured to perform steps described herein without the need for code. That is, for example, PC 602 may consist merely of one or more ASICs. Hence, the features of the embodiments described herein may be implemented in hardware and/or software.

While various embodiments of the present disclosure are described herein, it should be understood that they have been presented by way of example only, and not limitation. Thus, the breadth and scope of the present disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for managing resources, the method comprising:
applying an ensemble model, the ensemble model comprising a plurality of sub-models such that an output of the ensemble model is a weighted average of predictions from the sub-models, and such that the output is a prediction of multiple parameters;
determining that an accuracy of the ensemble model is below a first threshold; and
optimizing weights for the predictions from the sub-models as a result of determining than an accuracy of the trained ensemble model is below a first threshold, wherein
optimizing weights for the predictions from the sub-models comprises:
applying reinforcement learning, such that the weights are selected for a given time instance to improve prediction accuracy based at least in part on a reward function; and
updating the weights selected by the reinforcement learning by looking ahead over a prediction horizon and optimizing the reward function at the given time instance; and
using the prediction of the multiple parameters to manage resources.

2. The method of claim 1, wherein updating the weights selected by the reinforcement learning by looking ahead over a prediction horizon and optimizing the reward function at the given time instance comprises:
Step 1) initializing weights for the predictions from the sub-models;
Step 2) computing predictions of multiple parameters over the prediction horizon using the weights for the predictions from the sub-models;
Step 3) computing a minimization function to update the reward function to minimize prediction error, whereby the weights for the predictions from the sub-models are updated;
Step 4) computing the predictions of multiple parameters over the prediction horizon using the weights for the predictions from the sub-models that were updated in step 3; and
Step 5) determining whether a prediction error is less than a second threshold.

3. The method of claim 2, wherein as a result of step 5, it is determined that the prediction error is not less than a threshold, and updating the weights selected by the reinforcement learning further comprises:
discarding a sample used in step 2 for computing the predictions of multiple parameters over the prediction horizon using the weights for the predictions from the sub-models; and
repeating steps 2 through 5, until it is determined that the prediction error is less than the second threshold.

4. The method of claim 2, wherein computing the minimization function of step 3 comprises optimizing
_{R}^{min}Σᵢ₌ₖ₊₁^{k+N}(f(R,y[i−p],u[i−p])−y[i]), p=1,2,3 . . . ,
where R is the reward function, y[i] is the actual output calculated at the given time instant i, f(.) is the reinforcement learning model and u is the multiple parameters.

5. The method of claim 1, wherein at least one of the multiple parameters is related to a fault and wherein using the prediction of the multiple parameters to manage resources comprises assigning resources to correct the predicted fault.

6. The method of claim 1, wherein the multiple parameters includes (i) a location of a fault, (ii) a type of the fault, (iii) a level of a node where the fault occurred, and (iv) a time of the fault.

7. The method of claim 6, wherein using the prediction of the multiple parameters to manage resources comprises applying an integer linear programming (ILP) problem as follows:
$${\sum }_{{ }^{{{a}_{ij}}^{j = 1}}}^{{min}_{M}} {\sum }_{i = 1}^{N} {a}_{j i} d + {\sum }_{j = 1}^{M} {\sum }_{i = 1}^{N} {a}_{j i} {t}_{j i}$$
$$subject to \{ \begin{matrix}{\sum }_{j = 1}^{M} {\sum }_{i = 1}^{N} {a}_{j i} = M \\ {\sum }_{j = 1}^{M} {a}_{j i} \leq 1 ∀ i = 1 , . . . , N \\ {a}_{j i} = \{ 0 , 1 \} \\ Additional Constraints\end{matrix}$$
where d is the distance to the location of the fault, and tᵢⱼ is the time taken by resource i to reach the location j, where M is a total number of predicted faults in a time period, where the constraint Σⱼ₌₁^{M} Σᵢ₌₁^{N} aⱼᵢ=M ensures that there are M resources assigned, where the constraint Σⱼ₌₁^{M} aⱼᵢ≤1∀i=1, . . . , N ensures that almost one object is assigned to one resource, and where the constraint aⱼᵢ={0,1} ensures a resource is either selected or not.

8. The method of claim 1, wherein using the prediction of the multiple parameters to manage resources comprises assigning human resources based on one or more of the multiple parameters.

9. The method of claim 1, wherein using the prediction of the multiple parameters to manage resources comprises assigning computing resources based on one or more of the multiple parameters.

10. A node adapted for managing resources, the node comprising:
a data storage system; and
a data processing apparatus comprising a processor, wherein the data processing apparatus is coupled to the data storage system, and the data processing apparatus is configured to:
apply an ensemble model, the ensemble model comprising a plurality of sub-models such that an output of the ensemble model is a weighted average of predictions from the sub-models, and such that the output is a prediction of multiple parameters;
determine that an accuracy of the ensemble model is below a first threshold; and
optimize weights for the predictions from the sub-models as a result of determining than an accuracy of the trained ensemble model is below a first threshold, wherein
optimizing weights for the predictions from the sub-models comprises:
applying reinforcement learning, such that the weights are selected for a given time instance to improve prediction accuracy based at least in part on a reward function; and
updating the weights selected by the reinforcement learning by looking ahead over a prediction horizon and optimizing the reward function at the given time instance; and
use the prediction of the multiple parameters to manage resources

11. The node of claim 10, wherein updating the weights selected by the reinforcement learning by looking ahead over a prediction horizon and optimizing the reward function at the given time instance comprises:
Step 1) initializing weights for the predictions from the sub-models;
Step 2) computing predictions of multiple parameters over the prediction horizon using the weights for the predictions from the sub-models;
Step 3) computing a minimization function to update the reward function to minimize prediction error, whereby the weights for the predictions from the sub-models are updated;
Step 4) computing the predictions of multiple parameters over the prediction horizon using the weights for the predictions from the sub-models that were updated in step 3; and
Step 5) determining whether a prediction error is less than a second threshold.

12. The node of claim 11, wherein as a result of step 5, it is determined that the prediction error is not less than a threshold, and updating the weights selected by the reinforcement learning further comprises:
discarding a sample used in step 2 for computing the predictions of multiple parameters over the prediction horizon using the weights for the predictions from the sub-models; and
repeating steps 2 through 5, until it is determined that the prediction error is less than the second threshold.

13. The node of claim 11, wherein computing the minimization function of step 3 comprises optimizing
_{R}^{min}Σᵢ₌ₖ₊₁^{k+N}(f(R,y[i−p],u[i−p])−y[i]), p=1,2,3 . . . ,
where R is the reward function, y[i] is the actual output calculated at the given time instant i, f(.) is the reinforcement learning model and u is the multiple parameters.

14. The node of claim 10, wherein at least one of the multiple parameters is related to a fault and wherein using the prediction of the multiple parameters to manage resources comprises assigning resources to correct the predicted fault.

15. The node of claim 10, wherein the multiple parameters includes (i) a location of a fault, (ii) a type of the fault, (iii) a level of a node where the fault occurred, and (iv) a time of the fault.

16. The node of claim 15, wherein using the prediction of the multiple parameters to manage resources comprises applying an integer linear programming (ILP) problem as follows:
$${{\sum }_{{{a}_{ij}}^{j = 1}}}^{{mi n}_{M}} {\sum }_{i = 1}^{N} {a}_{j i} d + {\sum }_{j = 1}^{M} {\sum }_{i = 1}^{N} {a}_{j i} {t}_{j i}$$
$$subject to \{ \begin{matrix}{\sum }_{j = 1}^{M} {\sum }_{i = 1}^{N} {a}_{j i} = M \\ {\sum }_{j = 1}^{M} {a}_{j i} \leq 1 ∀ i = 1 , . . . , N \\ {a}_{j i} = \{ 0 , 1 \} \\ Additional Constraints\end{matrix}$$
where d is the distance to the location of the fault, and tᵢⱼ is the time taken by resource i to reach the location j, where M is a total number of predicted faults in a time period, where the constraint Σⱼ₌₁^{M} Σᵢ₌₁^{N} aⱼᵢ=M ensures that there are M resources assigned, where the constraint Σⱼ₌₁^{M} aⱼᵢ≤1∀i=1, . . . , N ensures that almost one object is assigned to one resource, and where the constraint aⱼᵢ={0,1} ensures a resource is either selected or not.

17. The node of claim 10, wherein using the prediction of the multiple parameters to manage resources comprises assigning human resources based on one or more of the multiple parameters.

18. The node of claim 10, wherein using the prediction of the multiple parameters to manage resources comprises assigning computing resources based on one or more of the multiple parameters.

19. (canceled)

20. A non-transitory computer readable medium storing a computer program comprising instructions which when executed by processing circuitry of a node causes the node to perform the method of claim 1.

21. (canceled)
